(19) United States
(12) Patent Application Publication
(10) Pub. No.: US 2017/0160528 A1
(43) Pub. Date: Jun. 8, 2017

(54) LIGHT COLLECTING MODULE

(71) Applicant: Metal Industries Research & Development Centre, Kaohsiung (TW)

(72) Inventors: Zong-Hsin Liu, Kaohsiung City (TW); Fu-Chuan Hsu, Kaohsiung City (TW); Cheng-Tang Pan, Kaohsiung City (TW); Yen-Po Sun, Kaohsiung City (TW); Chung-Kun Yen, Kaohsiung City (TW); Wen-Jiun Liu, Taipei City (TW); Hsuan-Cheng Liu, Kaohsiung City (TW)

(21) Appl. No.: 14/958,944

(22) Filed: Dec. 4, 2015

(51) Int. Cl. G02B 19/00; G02B 27/30

(52) U.S. Cl. CPC G02B 19/0042; G02B 19/0023; G02B 27/30

(57) ABSTRACT

A light collecting module that includes at least one light concentrating unit, at least one collimating unit, and a focusing mirror is provided. The light concentrating unit has a light input end and a light output end opposite to the light input end, and the light concentrating unit is configured to collect lights at various incident angles through the light input end and concentrate the lights on the light output end. The collimating unit collimates the lights from the light output end of the light concentrating unit. The focusing mirror focuses the collimated lights from the collimating unit on a focus of the focusing mirror.

### FIELD OF INVENTION

The invention relates to an optical module, and more particularly to a light collecting module.

### DESCRIPTION OF RELATED ART

Solar electricity generation can be categorized into photovoltaic (PV) power generation and concentric solar power (CSP) generation. The CSP generation may be associated with a synchronous power generator, and the CSP generating machine is the same as the petrochemical fuel power generation machine and the nuclear power generation machine and thus is compatible with the existing electric grid. The capacity factor of the CSP generating machine can reach 85%, i.e., the CSP generating machine can spend 85% of the time in a year on generating power (i.e., base load power). If the power is converted into a high-voltage direct current (HVDC) electric power, the converted power can be transmitted remotely. According to an evaluation done by Spain, if the distance of the electric power transmission is 2,000 kilometers, the electric power loss is 8.1%; when evaluated by the United States, if the distance of the electric power transmission is 3,000 kilometers, the electric power loss is 11.5%.

By contrast, the PV plant can be easily established but cannot generate power at night or on a cloudy day. Besides, if the PV power generating machine is connected to the existing electric grid, a booster and an alternating current (AC) to direct current (DC) converter are required; therefore, the PV power generating machine is less stable and cannot easily distribute electric power. Due to instable climate changes, stable power supply requires storage of electricity or heat while the amount of sunlight is sufficient. The PV power generation requires cells for power storage, and the CSP generation requires a heat storage tank for heat storage, so as to generate power at night or on the cloudy day.

The solar energy is collected by applying a light concentrating method for either the PV power generation or the CSP generation. According to the normal light concentrating method, one single reflection mirror or one single focusing lens is employed to focus lights, which is one of the easiest ways but not the most effective way to concentrate the lights. If only the reflection mirror is employed, the focus is easily shifted as long as the lights slightly deflect. Even though an active solar tracking system may be applied to track the direction of the sunlight, the active solar tracking system is overly pricey. By contrast, if only the focusing lens is applied, the issue of light loss may arise on the edge or corner of the lens, and the lights cannot be well concentrated.

### SUMMARY

The invention is directed to a light collecting system capable of effectively concentrating incident lights at various angles.

In an embodiment of the invention, a light collecting module that includes at least one light concentrating unit, at least one collimating unit, and a focusing mirror is provided. The light concentrating unit has a light input end and a light output end opposite to the light input end, and the light concentrating unit is configured to collect lights at various incident angles through the light input end and concentrate the lights on the light output end. The collimating unit collimates the lights from the light output end of the light concentrating unit. The focusing mirror focuses the collimated lights from the collimating units on a focus of the focusing mirror.

According to an embodiment of the invention, the light concentrating unit is a compound parabolic concentrator.

According to an embodiment of the invention, the collimating unit includes a first light input surface, a first light output surface, and a reflection surface. The first light input surface faces the light concentrating unit, and the first light output surface is opposite to the first light input surface. The reflection surface is connected between the first light input surface and the first light output surface. Here, a first portion of the light from the light concentrating unit is sequentially refracted by the first light input surface and the first light output surface so as to be collimated, and a second portion of the light from the light concentrating unit is reflected by the reflection surface.

According to an embodiment of the invention, the second portion of the light is sequentially refracted by the first light input surface and reflected by the reflection surface so as to be collimated.

According to an embodiment of the invention, the first light input surface is a curved concave surface, and the first light output surface is a curved convex surface.

According to an embodiment of the invention, each of the collimating units further includes a second light input surface and a second light output surface. The second light input surface surrounds the first light input surface, and the second light output surface surrounds the first light output surface. The second portion of the light is sequentially refracted by the second light input surface, reflected by the reflection surface, and refracted by the first light output surface so as to be collimated, and a third portion of the light from the light concentrating unit is sequentially refracted by the second light input surface and the second light output surface so as to be collimated.

According to an embodiment of the invention, the first light input surface is a curved convex surface, the second light input surface is a curved concave surface, the first light output surface is a curved concave surface, and the second light output surface is a curved convex surface.

According to an embodiment of the invention, the reflection surface totally reflects the second portion of the light from the light concentrating unit.

According to an embodiment of the invention, the reflection surface is a free-form surface.

According to an embodiment of the invention, the focusing mirror is a parabolic mirror.

According to an embodiment of the invention, a reflection surface of the light concentrating unit and a reflection surface of the focusing mirror are coated with coating films capable of reflecting infrared light.

According to an embodiment of the invention, a reflection surface of the light concentrating unit and a reflection surface of the focusing mirror are coated with coating films capable of reflecting visible light.

According to an embodiment of the invention, the light concentrating unit has an optical axis, and the light concentrating unit is configured to concentrate lights, whose incident directions are inclined relative to the optical axis of the light concentrating unit by inclined angles, at the light output end. Here, each of the inclined angles is less than 90 degrees.

According to an embodiment of the invention, the light concentrating unit has an optical axis, and the light concentrating unit concentrates lights, whose incident directions are inclined relative to the optical axis of the light concentrating unit by angles, at the light output end. Here, a maximum value of the angles is less than or equal to 60 degrees.

In the light collecting module provided herein, the light concentrating unit is first applied to concentrate lights, the collimating unit is then employed to collimate the lights, and the collimated lights are then focused by the focusing mirror. The light concentrating unit is configured to concentrate the lights at various incident angles from the light input end, and therefore the light collecting module is able to effectively focus the incident lights at various angles on the focus of the focusing mirror. Thereby, the efficient and cost-effective light collecting module can be achieved and replace the pricey active sunlight tracking system.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate embodiments and, together with the description, serve to explain the principles of the disclosure.

FIG. 1A is a three-dimensional see-through view illustrating a light collecting module according to an embodiment of the invention.

FIG. 1B is a schematic cross-sectional view illustrating the light collecting module in FIG. 1A.

FIG. 2 is a schematic cross-sectional view illustrating the light concentrating unit and the collimating unit in FIG. 1A.

FIG. 3 is a schematic cross-sectional view illustrating the collimating unit in FIG. 1.

FIG. 4 is a schematic cross-sectional view illustrating a collimating unit of a light collecting module according to another embodiment of the invention.

FIG. 5 is a schematic cross-sectional view illustrating a light collecting module according to another embodiment of the invention.

### DETAILED DESCRIPTION OF DISCLOSED EMBODIMENTS

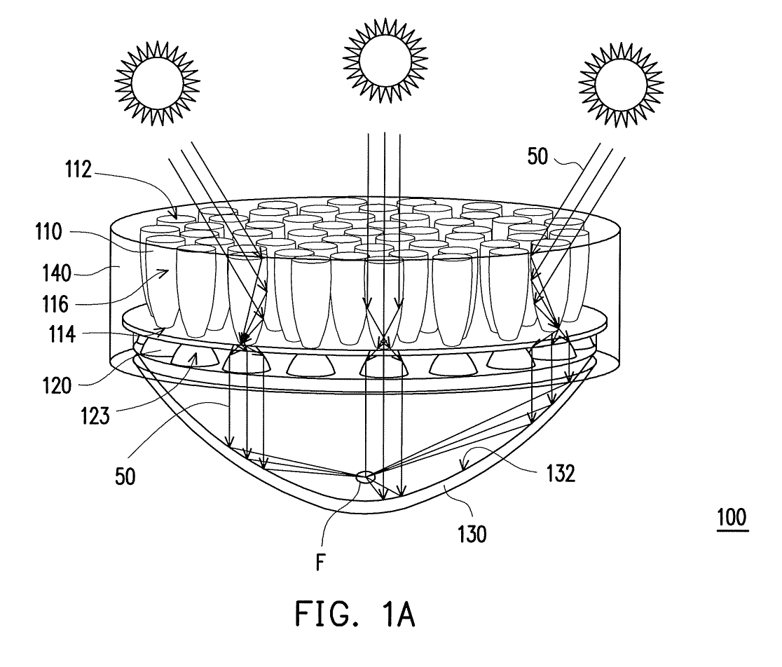

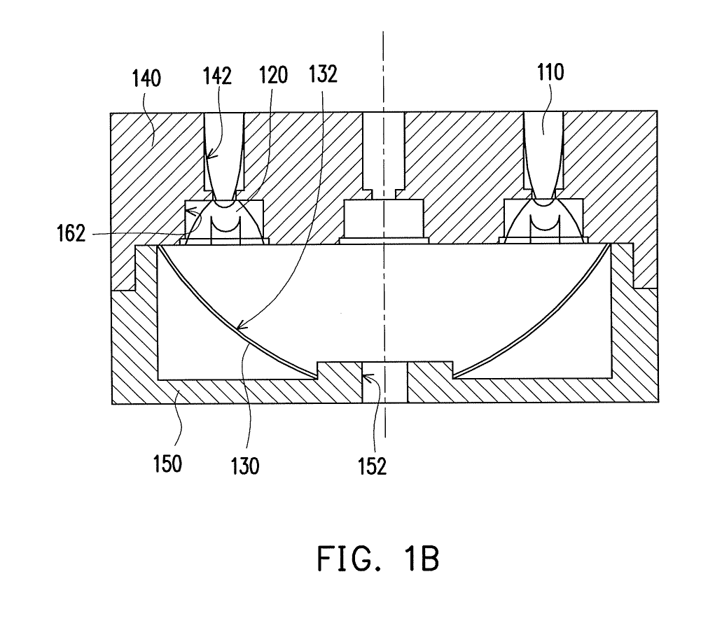

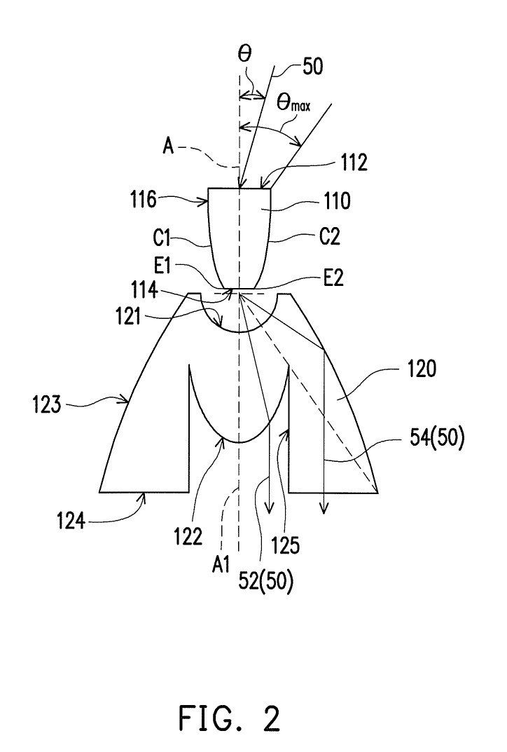

FIG. 1A is a three-dimensional see-through view illustrating a light collecting module according to an embodiment of the invention. FIG. 1B is a schematic cross-sectional view illustrating the light collecting module in FIG. 1A. FIG. 2 is a schematic cross-sectional view illustrating the light concentrating unit and the collimating unit in FIG. 1A. FIG. 3 is a schematic cross-sectional view illustrating the collimating unit in FIG. 1. With reference to FIG. 1A to FIG. 3, a light collecting module 100 provided in the present embodiment includes a plurality of light concentrating units 110, a plurality of collimating units 120, and a focusing mirror 130. Each of the light concentrating units 110 has a light input end 112 and a light output end 114 opposite to the light input end 112, and each of the light concentrating units 110 is configured to collect lights at various incident angles (e.g., the sunlight at different time points in one day) through the light input end 112 and concentrate the lights on the light output end 114.

According to the present embodiment, each of the light concentrating units 110 is a compound parabolic concentrator. Specifically, each of the light concentrating units 110 has a side surface 116 connecting the light input end 112 and the light output end 114, and the side surface 116 is a compound parabolic surface. A method of forming the compound parabolic surface is described below. A cross-section of the light concentrating unit 110 is obtained by cutting the light concentrating unit 110 along an optical axis A of the light concentrating unit 110, and a section line C1 of the side surface 116 on the left portion of FIG. 2 and a section line C2 of the side surface 116 on the right portion of FIG. 2 are both parabolas. Here, a focus of the section line C1 (i.e., the parabola) is located at an end point E2 where the section line C2 is connected to the light output end 114, and a focus of the section line C2 (i.e., the parabola) is located at an end point E1 where the section line C1 is connected to the light output end 114. The section lines C1 and C2 are rotated around the optical axis A, and the resultant curved surface is the so-called compound parabolic surface. The side surface 116 is a reflection surface and may be coated with a reflection layer (e.g., the entire side surface 116 may be coated with the reflection layer), so as to reflect the lights at various incident angle from the light input end 112 to the light output end 114, e.g., reflect the lights to around the intersection of the side surface 116 and the light output end 114. In the present embodiment, the space defined by the light input end 112, the light output end 114, and the side surface 116 may be filled with a light guiding medium (e.g., a transparent medium), and the side surface 116 is coated with the reflection layer. However, in other embodiments of the invention, the space defined by the light input end 112, the light output end 114, and the side surface 116 may be filled with gas or air, i.e., each of the light concentrating units 110 may be a hollow light concentrating unit, and the side surface 116 is constituted by a reflection surface of a reflector.

According to the present embodiment of the invention, each of the light concentrating units 110 has the optical axis A, and each of the light concentrating units 110 is configured to concentrate lights at the light output end 114. Here, the incident directions of the concentrated lights are inclined relative to the optical axis A of each of the light concentrating units 110 by inclined angles θ, and each of the inclined angles θ is less than 90 degrees. For instance, each of the light concentrating units 110 concentrates lights, whose incident directions are inclined relative to the optical axis A of each of the light concentrating units 110 by angles, at the light output end 114, and a maximum value θₘₐₓ of the angles is less than or equal to 75 degrees. The maximum angle θₘₐₓ is the maximum incident angle that is acceptable to each of the light concentrating units 110. The maximum angle θₘₐₓ may be located on the right side of the optical axis A (as shown in FIG. 2), on the left side of the optical axis A, or in any of directions rotated with the optical axis A as the rotation center. In an embodiment of the invention, the maximum angle θₘₐₓ may be less than or equal to 60 degrees. In an embodiment of the invention, the maximum angle θₘₐₓ may be from greater than or equal to 0 degrees to greater than or equal to 60 degrees. Thereby, the light concentrating units 110 are able to collect the sunlight in a period in a day during which the maximum solar radiation can be received, e.g. in the period from 9 am to 3 pm. In an embodiment of the invention, the light concentrating units 110 may be arranged in an array or may be distributed on one plane in any way, so as to enhance the amount of the collected sunlight.

The collimating units 120 collimate the lights from the light output ends 114 of the light concentrating units 110, respectively. In the present embodiment, the collimating units 120 are respectively arranged beside the light output ends 114 of the light concentrating units 110, and each of the collimating units 120 includes a first light input surface 121, a first light output surface 122, and a reflection surface 123. The first light input surface 121 faces a corresponding light concentrating unit 110 of the light concentrating units 110, and the first light output surface 122 is opposite to the first light input surface 121. The reflection surface 123 is connected between the first light input surface 121 and the first light output surface 122. Here, a first portion 52 of the light 50 from the corresponding light concentrating unit 110 is sequentially refracted by the first light input surface 121 and the first light output surface 122 so as to be collimated, and a second portion 54 of the light 50 from the corresponding light concentrating unit 110 is reflected by the reflection surface 123.

In the present embodiment, the second portion 54 of the light 50 is sequentially refracted by the first light input surface 121 and reflected by the reflection surface 123 so as to be collimated. The reflection surface 123 provided herein totally reflects the second portion 54 of the light 50 from the corresponding light concentrating unit 110. Namely, the reflection surface 123 is a total reflection surface, for instance. However, in another embodiment, the reflection surface may be coated with a reflection film.

According to the present embodiment, the first light input surface 121 is a curved concave surface, for instance, and the first light output surface 122 is a curved convex surface, for instance. In addition, the reflection surface 123 provided in the present embodiment is a free-form surface, for instance. Each of the collimating units 120 has an optical axis A1, and each surface of the collimating unit 120 is axially symmetrical with the optical axis A1 as the symmetrical axis. The light axes A1 of collimating units 120 and the light axes A of the light concentrating units 110 may coincide with each other, respectively. Each of the collimating units 120 may further have a light output surface 124 and an inner surface 125. The light output surface 124 is connected between the reflection surface 123 and the first light output surface 122, and the inner surface 125 connects the light output surface 124 and the first light output surface 122. The second portion 54 of the light 50 totally reflected by the reflection surface 123 may leave the collimating units 120 in a collimating manner from the light output surface 124. In the present embodiment, the first light input surface 122 may not be a spherical surface, and a section line obtained through cutting the first light input surface 122 by any plane having the optical axis A1 is a portion of an ellipse, for instance. Together with the first light output surface 122 and the reflection surface 123, the first light input surface 121 is able to collimate the lights 50 from the light output ends 114 of the light concentrating units 110 in a more effective manner.

The focusing mirror 130 focuses the collimated lights 50 from the collimating units 120 on a focus F of the focusing mirror 130. In the present embodiment, the focusing mirror 130 is a parabolic mirror; that is, an inner surface 132 of the focusing mirror 130 may be a paraboloid and may be coated with a reflection film (e.g., the entire inner surface 132 is coated with the reflection film), so as to reflect the collimated lights 50 and focus the reflected lights on the focus F of the paraboloid. After passing through the light concentrating units 110 and the collimating units 120, the lights 50 at different incident angles are all collimated; hence, the focusing mirror 130 is able to well focus the lights 50 on the focus F of the focusing mirror 130. Thereby, the efficient and cost-effective light collecting module 100 can be achieved and replace the conventional pricey active sunlight tracking system.

The light collecting module 100 provided in the present embodiment can serve to concentrate solar energy; specifically, a heat collector or a photovoltaic cell may be placed at the focus F of the focusing mirror 130, so as to collect the heat energy from the sunlight or convert the light energy into electric energy. Alternatively, an opening may be arranged at the focus F and coupled to an optical fiber, such that the lights 50 can be guided to the outside of the focusing mirror 130 through the optical fiber for illumination. The optical fiber may also be coupled to the heat collector or the photovoltaic cell on the outside of the focusing mirror 130, so as to collect the heat energy from the sunlight or convert the light energy into electric energy.

In an embodiment of the invention, a reflection surface of each of the light concentrating units 110 and a reflection surface of the focusing mirror 130 (e.g., the side surface 116 of each of the light concentrating units 110 and the inner surface 132 of the focusing mirror 130) are coated with coating films capable of reflecting infrared light, and the coating films may be characterized by a high infrared reflectivity, so as to efficiently focus the heat energy from the sunlight on the focus F. In another embodiment of the invention, a reflection surface of each of the light concentrating units 110 and a reflection surface of the focusing mirror 130 (e.g., the side surface 116 of each of the light concentrating units 110 and the inner surface 132 of the focusing mirror 130) are coated with coating films capable of reflecting visible light, and the coating films may be characterized by a high visible-light reflectivity, and the infrared light may penetrate the coating films. According to the present embodiment, a thermoelectric module may be arranged on a location where the infrared light may arrive after penetrating the coating films, so as to convert heat energy into electric energy. Additionally, after the visible light is reflected by the coating films, the reflected visible light can be focused on the focus F, such that the photovoltaic cell can convert light energy into electric energy, or the focused lights may be employed for illumination.

As shown in FIG. 1B, the light collecting module 100 provided in the present embodiment further includes a top cover 140 and a bottom cover 150. Note that FIG. 1A does not illustrate the bottom cover 150 but illustrate the focusing mirror 130 in the bottom cover 150. One end of the top cover 140 has a plurality of alignment holes 142 for respectively accommodating and fixing the light concentrating units 110. The other end of the top cover 140 has a plurality of accommodation spaces 162 for respectively accommodating and fixing the collimating units 120, and the accommodation spaces 162 are respectively opposite to the alignment holes 142. The bottom cover 150 may be locked to the top cover 140 and may be configured to fix the focusing mirror 130. In the present embodiment, the bottom cover 150 has an opening 152 for communicating with the focus F of the focusing mirror 130. Thereby, the lights can be guided to the outside through the opening 152; for instance, the optical fiber may be extended to the outside from the focus F through the opening 152.

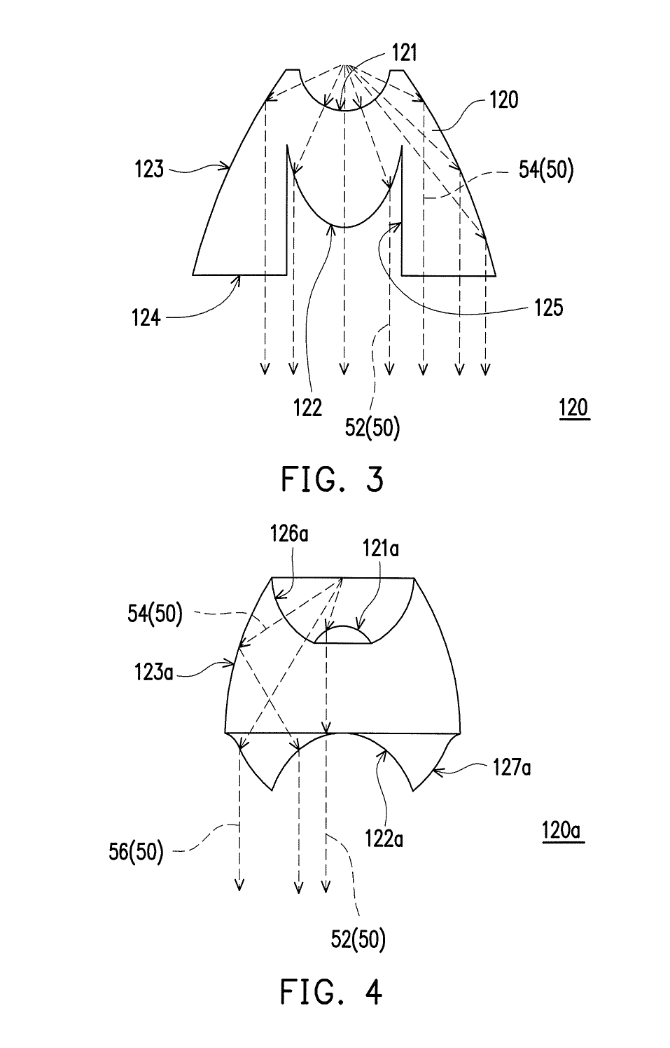

FIG. 4 is a schematic cross-sectional view illustrating a collimating unit of a light collecting module according to another embodiment of the invention. With reference to FIG. 4, the light collecting module provided in the present embodiment is similar to the light collecting module 100 depicted in FIG. 1A, and the difference between these two light collecting modules lies in the collimating units 120a provided in the present embodiment. Specifically, the collimating units 120a described in the present embodiment are similar to the collimating units 120 depicted in FIG. 3, and the difference between the collimating units 120a and 120 is described below. In the present embodiment, each of the collimating units 120 not only includes the first light input surface 121a, the first light output surface 122a, and the reflection surface 123a but also includes a second light input surface 126a and a second light output surface 127a. The second light input surface 126a surrounds the first light input surface 121a, and the second light output surface 127a surrounds the first light output surface 122a. The second portion 54 of the light 50 is sequentially refracted by the second light input surface 126a, reflected by the reflection surface 123a, and refracted by the first light output surface 122a so as to be collimated, and a third portion 56 of the light 50 from the corresponding light concentrating unit 110 is sequentially refracted by the second light input surface 126a and the second light output surface 127a so as to be collimated.

According to the present embodiment of the invention, the first light input surface 121a is a curved convex surface, the second light input surface 126a is a curved concave surface, the first light output surface 122a is a curved concave surface, and the second light output surface 127a is a curved convex surface.

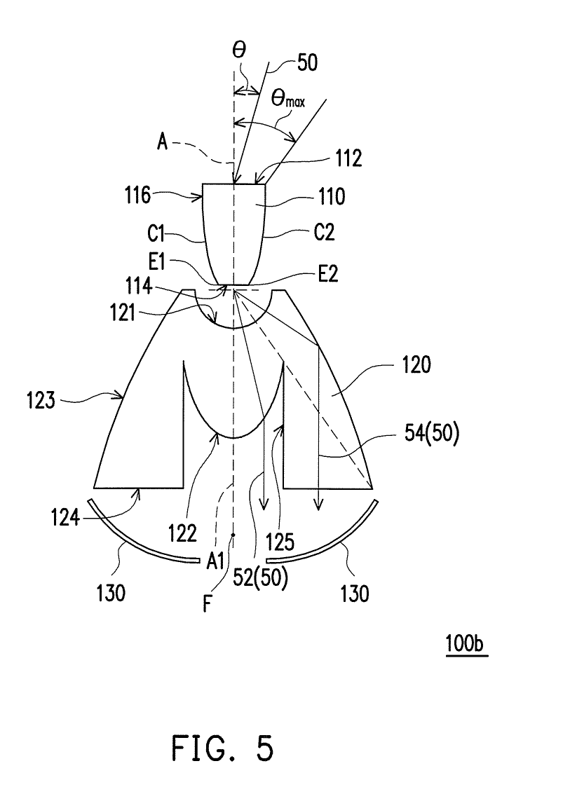

FIG. 5 is a schematic cross-sectional view illustrating a light collecting module according to another embodiment of the invention. Referring to FIG. 5, the light collecting module 100b in this embodiment is similar to the light collecting module 100 in FIG. 1A, and the main difference therebetween is that the number of the light concentrating unit 110 included by the light collecting module 100b in this embodiment is one, and the number of the collimating unit included by the light collecting module 100b in this embodiment is one. The focusing mirror 130 focuses the light from the single collimating unit 120 on the focus F of the focusing mirror 130. The effect achieved by the light collecting module 100b in this embodiment is similar to that achieved by the light collecting module 100, and is not repeated herein.

To sum up, in the light collecting module provided herein, the light concentrating unit is first applied to concentrate lights, the collimating unit is then employed to collimate the lights, and the collimated lights are then focused by the focusing mirror. The light concentrating unit is configured to concentrate the lights at various incident angles from the light input end, and therefore the light collecting module is able to effectively focus the incident lights at various angles on the focus of the focusing mirror. Thereby, the efficient and cost-effective light collecting module can be achieved and replace the pricey active sunlight tracking system.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A light collecting module comprising:
at least one light concentrating unit having a light input end and a light output end opposite to the light input end, the light concentrating unit being configured to collect lights at various incident angles through the light input end and concentrate the lights on the light output end;
at least one collimating unit collimating the lights from the light output end of the light concentrating unit; and
a focusing mirror focusing the collimated lights from the collimating unit on a focus of the focusing mirror.

2. The light collecting module as recited in claim 1, wherein the light concentrating unit is a compound parabolic concentrator.

3. The light collecting module as recited in claim 1, wherein the collimating units comprises:
a first light input surface facing the light concentrating unit;
a first light output surface opposite to the first light input surface; and
a reflection surface connected between the first light input surface and the first light output surface, wherein a first portion of the light from the light concentrating unit is sequentially refracted by the first light input surface and the first light output surface so as to be collimated, and a second portion of the light from the light concentrating unit is reflected by the reflection surface.

4. The light collecting module as recited in claim 3, wherein the second portion of the light is sequentially refracted by the first light input surface and reflected by the reflection surface so as to be collimated.

5. The light collecting module as recited in claim 3, wherein the first light input surface is a curved concave surface, and the first light output surface is a curved convex surface.

6. The light collecting module as recited in claim 3, wherein each of the collimating units further comprises:
a second light input surface surrounding the first light input surface; and
a second light output surface surrounding the first light output surface, wherein the second portion of the light is sequentially refracted by the second light input surface, reflected by the reflection surface, and refracted by the first light output surface so as to be collimated, and a third portion of the light from the light concentrating unit is sequentially refracted by the second light input surface and the second light output surface so as to be collimated.

7. The light collecting module as recited in claim 6, wherein the first light input surface is a curved convex surface, the second light input surface is a curved concave surface, the first light output surface is a curved concave surface, and the second light output surface is a curved convex surface.

8. The light collecting module as recited in claim 3, wherein the reflection surface totally reflects the second portion of the light from the light concentrating unit.

9. The light collecting module as recited in claim 3, wherein the reflection surface is a free-form surface.

10. The light collecting module as recited in claim 1, wherein the focusing mirror is a parabolic mirror.

11. The light collecting module as recited in claim 1, wherein a reflection surface of the light concentrating unit and a reflection surface of the focusing mirror are coated with coating films capable of reflecting infrared light.

12. The light collecting module as recited in claim 1, wherein a reflection surface of the light concentrating unit and a reflection surface of the focusing mirror are coated with coating films capable of reflecting visible light.

13. The light collecting module as recited in claim 1, wherein the light concentrating unit has an optical axis, the light concentrating unit is configured to concentrate lights, whose incident directions are inclined relative to the optical axis of the light concentrating unit by inclined angles, at the light output end, and each of the inclined angles is less than 90 degrees.

14. The light collecting module as recited in claim 1, wherein the light concentrating unit has an optical axis, the light concentrating unit concentrates lights, whose incident directions are inclined relative to the optical axis of the light concentrating unit by angles, at the light output end, and a maximum value of the angles is less than or equal to 60 degrees.
